(19) United States
(12) Patent Application Publication
(10) Pub. No.: US 2018/0347453 A1
(43) Pub. Date: Dec. 6, 2018

(54) RETAINING ELEMENT FOR A CONTROL DEVICE OF AN EXHAUST GAS TURBOCHARGER

(71) Applicant: IHI CHARGING SYSTEMS INTERNATIONAL GMBH, Heidelberg (DE)

(72) Inventors: Lorenz JAENIKE, Heidelberg (DE); Dirk NUSSHAG, Dossenheim (DE); Angelina WIDENMAIER, Leimen (DE); Viktor DICK, Mannheim (DE); Daniel JUST, Kronau (DE)

(73) Assignee: IHI CHARGING SYSTEMS INTERNATIONAL GMBH, Heidelberg (DE)

(21) Appl. No.: 16/101,715

(22) Filed: Aug. 13, 2018

Related U.S. Application Data
(63) Continuation-in-part of application No. PCT/EP2017/000180, filed on Feb. 9, 2017.

(30) Foreign Application Priority Data
Feb. 23, 2016 (DE) 10 2016 103 114.3

(51) Int. Cl. F02B 37/18; F16B 37/02; F16B 7/18

(52) U.S. Cl. CPC F02B 37/186; F16B 7/182; F16B 37/02

(57) ABSTRACT

In a connecting element for a control device of an exhaust turbocharger which connecting element comprises a first element portion having a first passage opening a second element portion having a second passage opening, the first passage opening serves to connect the connecting element to the control device and the second passage opening serves to connect the connecting element to a movement device.

This is a continuation-in part application of pending international patent application PCT/EP2017/000180 filed 2017 Feb. 9 and claiming the priority of German patent application 10 2016 103 114.3 filed 2016 Feb. 23.

### BACKGROUND OF THE INVENTION

The invention relates to a retaining element for a control device of an exhaust turbocharger.

Exhaust turbochargers are known. They serve to increase the efficiency of internal combustion engines, to which they are thermodynamically and mechanically connected. In order to improve the operating behavior of the internal combustion engine and of the exhaust turbocharger, the exhaust turbocharger has a control device, by means of which an exhaust gas quantity flowing onto a turbine wheel of the exhaust turbocharger can be regulated. This control device can be designed in the form of a so-called waste gate, which has a bypass duct that can be opened and closed with the aid of a valve, or it can be designed in the form of an adjusting device which is arranged around the turbine wheel. An operating device for adjusting the regulating device can be moved with the aid of a control device to position the regulating device accordingly. The control device is connected to the movement device with the aid of a retaining or connecting element.

For instance, laid-open document DE 10 2013 202 191 A1 discloses a retaining element for a control device of an exhaust turbocharger, which is designed in the form of a screw-nut element. This screw-nut element is formed in two parts, consisting of a first element part and a second element part, wherein the first element part is screwed to the second element part in order to form the screw-nut element. The first element part serves to receive the movement device and the second element part serves to receive the control device. By reason of this two-part design, this retaining element is not suitable in particular for electrical control devices. Furthermore, the production thereof is costly in particular by reason of nut elements formed on both element parts.

The object of the present invention is to provide an improved connecting element for a control device of an exhaust turbocharger.

### SUMMARY OF THE INVENTION

In a connecting element for a control device of an exhaust turbocharger which connecting element comprises a first element portion having a first passage opening and a second element portion having a second passage opening, the first passage opening serves to connect the connecting element to the control device and the second passage opening serves to connect the connecting element to a movement device.

The inventive connecting element for a control device of an exhaust turbocharger comprises a first element portion, having a first receiving element, and a second element portion, having a second receiving element. The first receiving element serves to connect the retaining element to the control device and the second receiving element is provided for connecting the retaining element to a movement device. The movement device is designed for positioning a regulating device of the exhaust turbocharger. In accordance with the invention, the connecting element is designed for frictional and interlocking connection to a control rod of the control device, wherein the first element portion and the second element portion are formed in one piece together.

The advantage resides in the fact that no relative movement is possible between the first element portion and the second element portion and the connecting element simultaneously has a secure frictional and interlocking connection to the control rod. Therefore, the connecting element can be used both in pneumatic and electrical control devices. Furthermore, a substantially simpler and thus more cost-effective assembly is achieved.

In one embodiment, the first receiving element is designed in the form of a first passage opening and the second receiving element is designed in the form of a second passage opening. Since the receiving element is designed for fastening the control or movement device as passage openings, the connecting element can be produced cost-effectively by reason of its simple form. A further advantage is a saving on a securing element, as designed e.g. as a nut.

In a further embodiment of the connecting element in accordance with the invention, the first receiving element is designed for frictional and interlocking connection to a control rod of the control device. With the aid of the frictional and interlocking connection, a specific length of the movement device can be adjusted in a simple manner. A substantial advantage is a simple compensation of production tolerances which typically occur. Compensation is effected by simple rotation of the connecting element.

Preferably, the first receiving element is designed to be complementary to an end of the control rod, wherein the control rod is designed for frictional and interlocking connection to the connecting element, whereby the frictional and interlocking connection can be produced directly between the control rod and the connecting element without any further auxiliary components, such as e.g. a nut.

In a further embodiment of the invention, the first receiving element has an internal thread. During assembly, the connecting element can be screwed onto the control rod and for securing purposes a securing element, e.g. in the form of a nut, can be connected to the control rod, bracing the connecting element. This means that only the connecting element and the securing element are to be held in position during assembly because the connecting element and the securing element form a screw connection.

In a further embodiment, the connecting element has an attachment which is formed coaxially with the first receiving element. With the aid of this attachment, the frictional and interlocking connection e.g. in the form of a screw connection can be large enough even in a cost-effective design of the connecting element consisting of a thin metal sheet. Preferably, the attachment is formed on a first surface of the first element portion facing the second element portion because this region is easily accessible during assembly. A further advantage of this embodiment is the formation of a planar bearing surface for the securing element, preferably in the form of a nut.

For further cost-effective production of the connecting element, it is produced in a punching method.

In a further embodiment of the connecting element in accordance with the invention, a first element portion which is the first receiving element is designed for receiving standardized fixed or flat spanners. Therefore, during assembly of the connecting element, no tools which have to be specifically produced are required because typically standardised tools can be used, thus reducing assembly costs.

Advantages, features and details of the invention will be apparent from the following description of preferred exemplified embodiments described below with reference to the accompanying drawings. The features and combinations of features mentioned earlier in the description and the features and combinations of features mentioned hereinunder in the description of the figures and/or illustrated individually in the figures can be employed not only in the combination stated in each case but also in other combinations or on their own without departing from the scope of the invention. Like or functionally identical elements are allocated identical reference numerals.

### BRIEF DESCRIPTION OF THE DRAWINGS

FIG. 1 shows a side view of a connecting element and a control device of an exhaust turbocharger according to the prior art,

FIG. 2 shows a perspective view of a connecting element in accordance with the invention,

FIG. 3 shows a perspective first view of the connecting element of FIG. 2 in the installed state, and

FIG. 4 shows a perspective second view of the connecting element of FIG. 2 in the installed state.

### DESCRIPTION OF EXEMPLARY EMBODIMENTS

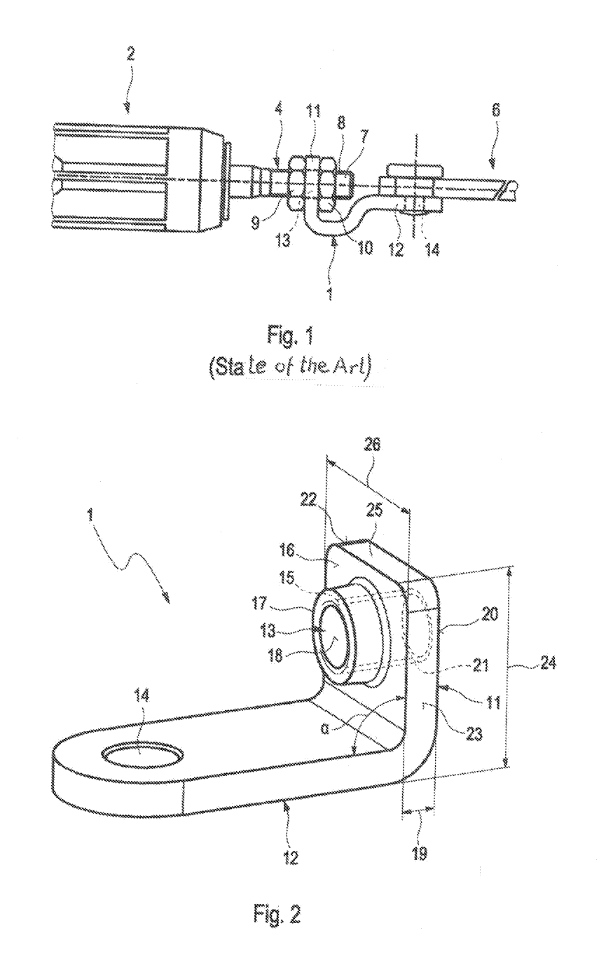

A connecting element 1 for a control device 2 of an exhaust turbocharger 3 according to a further prior art example is designed as shown in FIG. 1. The connecting element 1 serves to connect a control rod 4 of the control device 2 to a valve, not illustrated in greater detail, which is movably received in an exhaust gas conducting section 5 of the exhaust turbocharger 3. The valve is provided for opening and closing a flow deflection duct, not illustrated in greater detail, of the exhaust gas conducting section 5. With the aid of the flow deflection duct, gas which flows through the exhaust gas conducting section 5, typically exhaust gas of an internal combustion engine, not illustrated in greater detail, can be directed past a turbine wheel of the exhaust turbocharger 3. Such exhaust turbochargers 3 are adequately known and therefore shall not be explained in greater detail at this juncture.

In order to move the valve, it is connected to a corresponding movement device 6 which can be moved with the control rod 4. In other words, this means that the retaining element 1 is a connecting element for connecting the movement device 6 to the control device 2. The control device 2 is designed in the form of an electric actuator. The control rod 4 is designed for receiving the connecting element 1 at its end 7 facing the connecting element 1.

In order to receive the control rod 4, the connecting element 1 has, on a first element portion 11, a first receiving element 13 in the form of a passage opening and, for fastening with the movement device 6, has, on the second element portion 12, a second receiving element 14 likewise in the form of a passage opening. Both passage openings 13, 14 are formed as clearance holes.

In the present example, the control rod 4 is designed to protrude through the first passage opening 13 and to support the connecting element 1. The control rod 4 is provided with a thread 8 at its end portion 7 facing the connecting element 1. The connecting element 1 is positioned on the control rod 4 such that the end portion 7 having the thread 8 protrudes beyond the connecting element 1 on both sides.

In order to fix the retaining element 1 to the control rod 4, the connecting element 1 is received in a braced manner between a first securing element 9 and a second securing element 10 which can be screwed to the control rod 4. Both securing elements 9, 10 are designed in the form of a nut. By reason of the two securing elements 9, 10 which are to be fixed separately from one another during assembly, this connecting element 1 according to the prior art results in significant assembly outlay.

FIG. 2 shows a perspective view of a connecting element 1 in accordance with the invention. The connecting element 1 is formed in an angular manner. The first element portion 11 of the connecting element 1 which is arranged at an angle α of 90° to the second element portion 12 has the first passage opening 13 for receiving the control rod 4. The second passage opening 14 is formed on the second element portion 12 for the purpose of fastening the movement device 6.

The connecting element 1 is designed for frictional and interlocking connection to the control rod 4, wherein the first passage opening 13 has an internal thread 15 for the frictional and interlocking connection. The internal thread 15 is designed to be complementary to the thread 8 of the end portion 7 of the control rod 4 for the purpose of receiving the control rod 4 in a frictional and interlocking manner.

The connecting element 1 formed in the illustrated exemplified embodiment is produced cost-effectively with the aid of a punching method. Since a punching method produces predominantly thin-walled components, the connecting element 1 has, on its first surface 16 of the first element portion 11 facing the second element portion 12, a cylindrical attachment 17 which is provided with the internal thread 15 likewise on its inner surface 18. The attachment 17 is formed coaxially with the first passage opening 13.

In the illustrated exemplified embodiment, the attachment 17 is designed in one piece with the first element portion 11. Equally, the attachment 17 which is formed coaxially with the first passage opening 13 can also be designed as an external component and can be integrally connected to the connecting element 1.

If the first element portion 11 has a wall thickness 19 which is sufficient for forming a threaded portion 21 for connecting the control rod 4 to the connecting element 1 in a sufficiently fixed manner, the attachment 17 could be omitted.

Equally, the attachment 17 could also be formed on a second surface 20 of the first element portion 11 remote from the first surface 16.

The first element portion 11 is designed to receive a retaining tool in the form of a fixed or flat spanner. In other words, this means that a first side wall 22 extending between the first surface 16 and the second surface 20 is in parallel with an opposite second side wall 23. Furthermore, a height 24 starting from the second element portion 12 to a portion wall 25 extending between the first side wall 22 to the second side wall 23 is configured in dependence upon a spaced interval 26 between the first side wall 22 and the second side wall 23 such that a standardised spanner can be received.

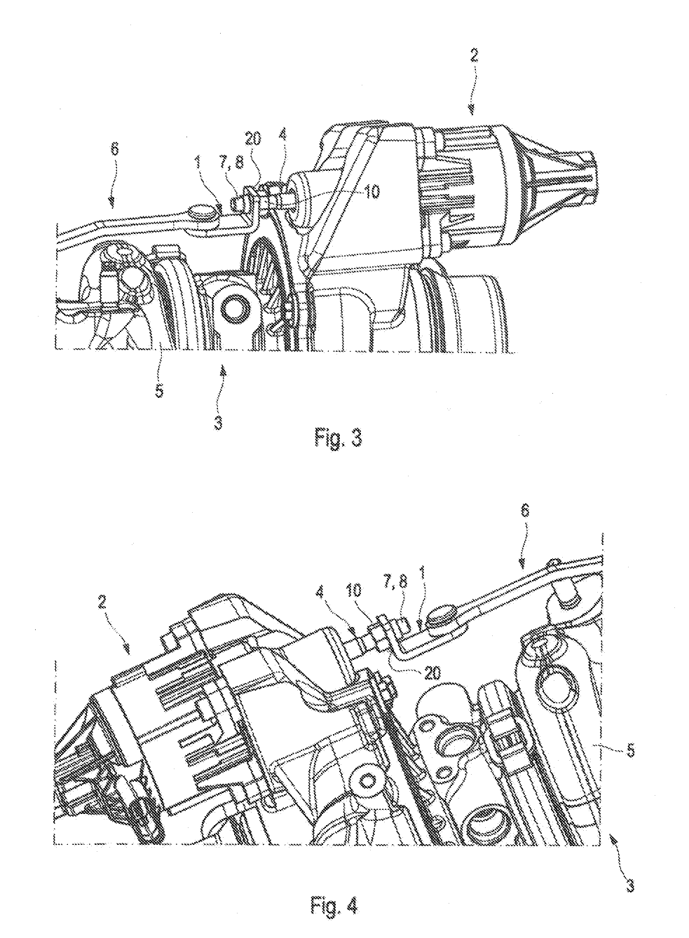

The connecting element 1 in accordance with the invention is illustrated in FIG. 3 in a perspective first view and is illustrated in FIG. 4 in a perspective second view in the installed state. In order to securely fix or brace the connecting element 1 on the control rod 4, the second nut 10 which secures the connecting element 1 is positioned on the control rod 4 adjacent the second surface 20 of said connecting element.

In an exemplary embodiment which is not illustrated in greater detail, the connecting element 1 in accordance with the invention is provided for adjusting a movable guide apparatus, a so-called VGS.

What is claimed is:

1. A connecting element for a control device (2) of an exhaust turbocharger (3), comprising a first element portion (11), having a first receiving element (13), and comprising a second element portion (12) having a second receiving element (14), wherein the first receiving element (13) serves to connect the connecting element (1) to the control device (2) and the second connecting element (14) serves to connect the connecting element (1) to a movement device (6), wherein the movement device (6) is designed to position a regulating device of the exhaust turbocharger (3), the connecting element (1) being designed for frictional and interlocking connection to a control rod (4) of the control device (2), and the first element portion (11) and the second element portion (12) being formed in one piece together.

2. The connecting element as claimed in claim 1, wherein the first receiving element (13) is designed in the form of a first passage opening and the second receiving element (14) is designed in the form of a second passage opening.

3. The connecting element as claimed in claim 1, wherein the first receiving element (13) is designed for frictional and interlocking connection to a control rod (4) of the control device (2).

4. The connecting element as claimed in claim 1, wherein the first receiving element (13) is designed to be complementary to an end (7) of the control rod (4), wherein the control rod (4) is designed for frictional and interlocking connection to the connecting element (1).

5. The connecting element as claimed in claim 1, wherein the first receiving element (13) has an internal thread (15).

6. The connecting element as claimed in claim 1, wherein
the connecting element (1) has an attachment (17) which is formed coaxially with the first receiving element (13).

7. The connecting element as claimed in claim 1, wherein the attachment (17) is formed on a first surface (16) of the first element portion (11) facing the second element portion (12).

8. The connecting element as claimed in claim 1, wherein the connecting element (1) is produced in a punching method.

9. The connecting element as claimed in claim 1, wherein a first element portion (11) which has the first receiving element (13) is designed for receiving a standard fixed or flat spanners.
